(19) United States
(12) Patent Application Publication
(10) Pub. No.: US 2010/0248661 A1
(43) Pub. Date: Sep. 30, 2010

(54) Activatable data transmitter system

(76) Inventor: Theodore Bullock, Delray Beach, FL (US)

Correspondence Address: FLASTER/GREENBERG P.C.;Four Penn Center, 1600 John F. Kennedy Boulevard, 2nd Floor, PHILADELPHIA, PA, 19103, US

(21) Appl. No.: 12/383,801

(22) Filed: Mar. 30, 2009

(51) Int. Cl. H04B 1/04

(52) U.S. Cl. 455/127.1

(57) ABSTRACT

A method of combining three types of technologies: wireless communication, a stand alone independent activatable power source and one or more sensors or detectors to form an Activatable Data Transmitter device (ADT) that can capture and transmit environmental data proximal to the ADT. In any specific application or use the sensor type and power component would be coupled or integrated with a wireless transmitter. Multiple and various ADT types would be employed in spaces or places where no battery or wired power source exists, access is difficult or impossible, use of wired power or wired signal or both would be expensive or impossible or some combination thereof. As part of the invention the ADTs would forward the sensed data to a Receiver System either directly for use, processing and/or display or via a Data Repeater.

### BACKGROUND OF THE INVENTION

Any number of prior art systems and components has been developed to monitor activities within buildings and in other spaces, including fire and smoke detention systems, burglar and security alarm systems and radiation or biohazard detection systems etc. Such systems are characterized by sensor devices that are capable of detecting, for example, smoke, fire or intrusion and are wired to a main console, panel or other device. When one or more of the sensor devices is stimulated, information is detected at or sent to the main console or panel indicating the location and sometimes other information about the location or environment. Systems which are wireless and/or which employ a radio link between sensor and receiver have been developed.

The prior art systems are disadvantageous in that the sensors require power sources such as a battery or a wired connection to an electrical power source. Systems using battery reliant sensors require vigilant maintenance to ensure that the batteries are replaced with sufficient frequency and those systems which use sensors wired to an electrical source are vulnerable to power outages in times of any catastrophe, including fire, storms, accidents or earthquake and/or may require a back up power source in the form of an auxiliary generator, which may be expensive, impractical and unreliable.

Also in many scenarios it is expensive and sometimes impractical or impossible to initially install and maintain these systems when they may need to be wired for power, use batteries that expire unpredictably or are in difficult to access places.

Thus, there remains in the art a need for a wireless data transmission system which can transmit data indicating the status of the near environment which may be closed as in a piping system or ductwork, in a open area outside or in a space such as in a building in which the system sensor is located remote to a receiver, but which does not rely on connected, expensive or unreliable power sources for its effectiveness.

### BRIEF SUMMARY OF THE INVENTION

The invention is characterized by the interconnection or integration of three technologies that create a unique use that can reduce the cost of collecting data and allow the collection of data in situations and scenarios never before possible. The three technologies: a wireless transmitter, sensor and detector devices and an independent non battery and non power grid component make up an Activatable Data Transmitter (ADT) capable of data collection independent of any power grid, battery or wiring. One or more self sufficient Activatable Data Transmitters (ADTs) send data wirelessly to a Receiver System either directly or via a customized Data Repeater. A significant attribute of the ADT is that it transmits data only when its power component is “activated”. The ADT, Data Repeater and Receiver System comprise the invention: the Activatable Data Transmitter System (ADT System). The invention enables the selection of one or more of various or different types of sensors/detectors with a selected type of activatable power generating component to wirelessly transmit data for use and/or display. The type of sensor/detector or input device, the activatable power generating component and the wireless transmission technology would be selected for each embodiment of the ADT based upon the intended use or requirement. The Receiver System would receive input from multiple or mixed ADT devices either directly or forwarded via the Data Repeater.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. It should be understood that the invention is not limited to the precise arrangements and instrumentalities shown or described herein. In the drawings:

FIG. 1 is an overall representation of the Activatable Data Transmitter System (ADT System).

FIG. 2 is a schematic representation illustrating the ADT System located in discrete space or in closed environments within the discrete space.

FIG. 3 is a schematic representation illustrating an ADT System measuring the attributes of the water flowing through the pipes of a piping system.

FIG. 4 is a schematic representation illustrating an ADT System having a gas driven activatable power generating source.

FIG. 5 is a schematic representation of another embodiment of the system illustrating an ADT using solar cells and/or a wind turbine as thectivatable power generating source.

FIG. 6 is a schematic representation of an example of the ADT System illustrating its use in a fire detection and suppression environment.

### DETAILED DESCRIPTION OF THE INVENTION

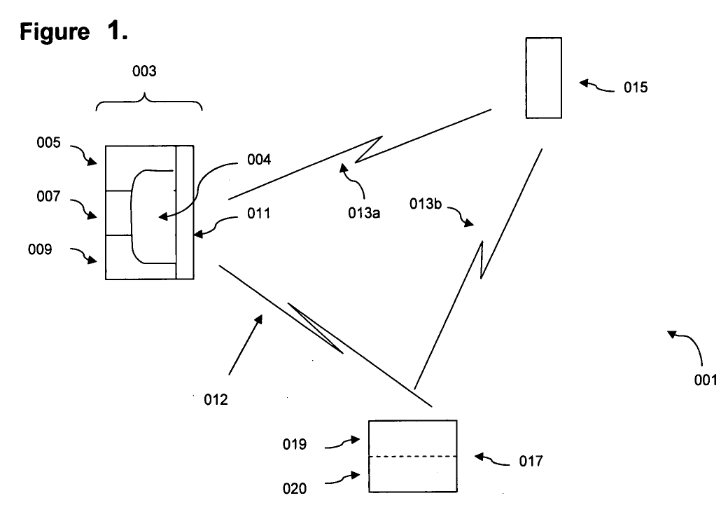

As shown in FIG. 1 the invention, Activatable Data Transmitter System 001, described herein includes one or more Activatable Data Transmitters (ADTs) 003, a Receiver System 017 that is composed of a data receiver 019 and also may include a computer based software application and display system or other device 020 that receives data transmitted 012 from one or more ADTs 003 and an optional Data Repeater 015 that can forward data 013a, 013b from multiple ADTs 003 to the Receiver System 017.

Again in FIG. 1 the ADT 003 which includes a wireless transmitter 011, one or more sensors or input devices 005, 007, 009 and a local activatable power generating component 004, is connected 012 through the wireless transmitter 011 to the Receiver System 017 (or indirectly connected 013a, 013b through the Data Repeater 015). The powering of the sensors 005, 007, 009 and the generation of the wireless signal 012, 013a is made possible through use of the activatable power generating component 004 since the ADT 003 is independent of any non rechargeable battery or wired electrical grid. Thus, the ADT 003 does not require constant battery replacement nor is it vulnerable to failure should the power source cease to function. It can, however easily function in an inaccessible area, space or location.

The invention includes the ADT which is capable of collecting data using sensors or input devices and transmitting it to a receiver located remotely from the ADT when activated. By “activatable” it is meant a transmitter that transmits data is activated by the application of power from the ADT's activatable power generating component thus allowing detection of the stimulus or stimuli to which the sensors correspond. The data sensed and transmitted is environmental data collected from the proximal area in which the ADT is located.

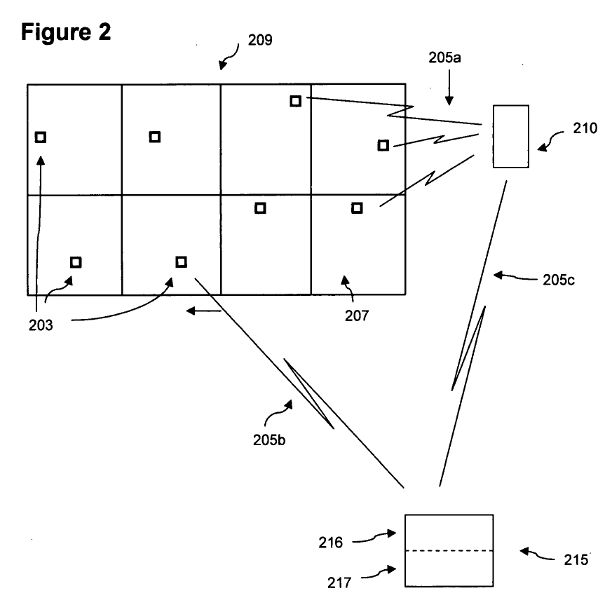

FIG. 2 is a generic embodiment of the invention showing a two dimensional layout of a three dimensional discrete space 209 such as a building. The ADTs 203 may be in the space 209 or a subspace (room) 207 as a sensing location or ductwork in a building or as a part of a structure such as the piping in a refinery. ADTs 203 when activated will transmit wireless data 205b to the receiver 216 of the Receiver System 215 or to a Data Repeater 210 that will be used to receive wirelessly transmitted data 205a from the ADT 203 and then retransmit 205c it to the receiver 216 of the Receiver System 215. Both scenarios are shown. In this case the “activation” may occur A. by the flow of liquid through a piping system in the space, B. by the flow if air through an air duct in the space, C. by the turning on of the lights or daylight in the space and/or other means. In these three examples the activatable power generating component of the ADT 203 is a A. water turbine, B. air/wind turbine or C. solar/light cell. The data received by the Receiver System 215 may be processed, displayed and/or used 217 depending upon the intended purpose or requirements.

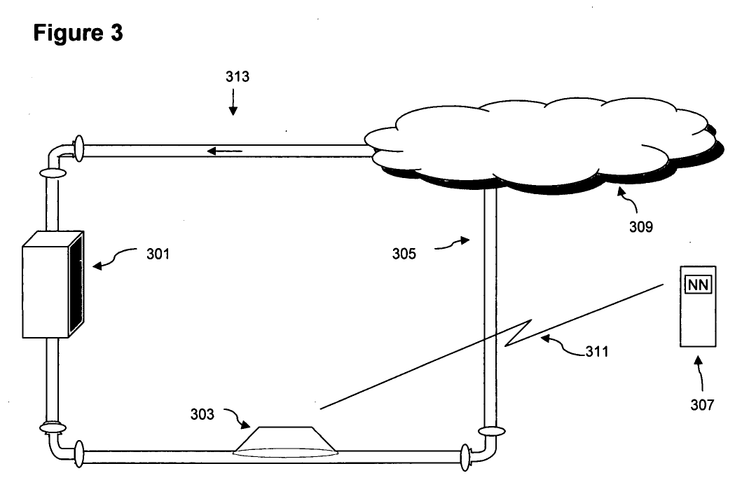

In one specific embodiment of the invention the ADT uses the motion or flow of a liquid, wind or gas to actuate a turbine that creates the power necessary to operate the wireless transmitter sending the sensed information. FIG. 3 is swimming pool system where the flow of water creates the power by “activating” the ADT 303. The water pipe 313 is part of the swimming pool 309 water circulation system where the water flows past the turbine component of the ADT 303 with the sensor component measuring the temperature, flow speed and/or chemistry of the pool water then transmitting 311 that data wirelessly to a the Receiver System 307. In this embodiment the ADT transmits directly to the Receiver System 307 which displays the data. If there is no transmission or the transmission stops, that is an indicator unto itself to the Receiver System 307 that there is no flow. FIG. 3 also shows the possible presence of a filter, pump, heater or other in line device 301 operated separately from the ADT 203. This example also applies to the flow through a closed piping systems containing liquid, gas or flowing material.

Such data transmitted wirelessly by the ADT may take the form of a message envelope or a continuous or intermittent stream of data which may include ADT unit identifier, control sequences, message format information, the data from the sensor and other information all unique to the ADT, its environment and purpose. It may also include data programmed into the ADT.

Data is collected and forwarded as shown in FIG. 7. Data from one or more sensors 705, 706, 707 of the ADT 703 is transmitted 712a, 712b from the wireless transmitter 711 and will be received wirelessly by either the receiver 719 of the Receiver System 717 or Data Repeater 715 receiver 709. This transmitted data may have also been collected by a data collecting device 721 (such as, for example, photo camera, a video camera, a microphone, GPS or other data device) linked to, connected to 723 or integrated with the ADT 703. The Data Repeater 715 and/or Data Receiver 717 may be powered by a conventional wired electrical grid or battery. The Data Repeater's 715 transmitter 701 and the Data Receiver's 717 receiver 719 may permit transmission and receipt of data using available communication technologies both wireless and/or non wireless. Additionally the Data Repeater 715 when optionally employed sends data received wirelessly 712a from the ADT 703 to the Receiver System 717 either wirelessly and/or non wirelessly 713 depending on the technology chosen for the requirement.

Another embodiment of the invention is as an enhancement to a door closer device using as its activatable power generating component in the ADT, a kinetic generator, similar to those found in kinetic flashlights. In the case of the door closer, the opening of the door provides power to send a wireless signal indicating sensed door movement, infrared, picture and/or video data to the Receiver System

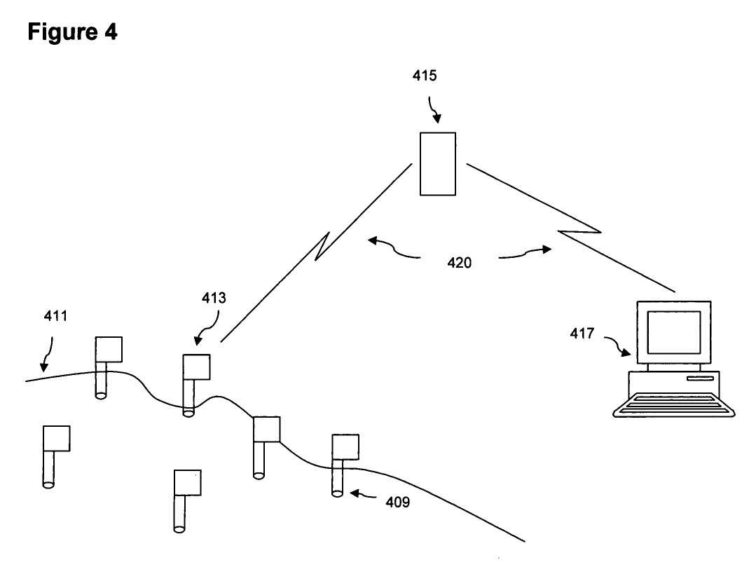

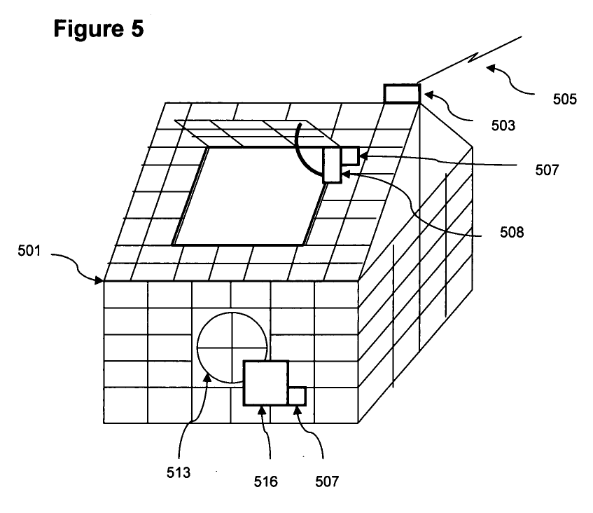

The ADT may further include an activatable power generating component that would be powered by the materials, attributes or components actually being sensed or present in the sensed environment. Examples are the use of the actual liquid (gasoline), gas (natural gas, propane), wind (air pipeline), chemical (acid), light (solar), elements and/or other material in the environment being measured or sensed to operate the activatable power generating component of the ADT. FIG. 4 shows using methane gas emitted through pipes buried 409 in a waste dump 411 where the ADT 413 uses the escaping gas to fuel or operate the activatable power generating component which powers the sensor(s) measuring the methane level (and/or other attributes) then transmitting the data wirelessly 420 to the Data Repeater 415 then the Receiver System 417. FIG. 5 shows the use of solar cells and/or a wind turbine as the activatable power generating component of the ADT 503 in a greenhouse 501 to measure the brightness, airflow, temperature and/or other attributes and wirelessly transmitting 505 the data. This example shows data transmitted from the ADT 503 directly to Receiver Systems 507 where command data is forwarded to the controls 508 that operate the window and control the fan 513 motor 516.

Another embodiment is the use of an ADT integrated with or connected to a wheel of a cart, vehicle or other moving device. The wheel drives a motion generator as the activatable power generating component of the ADT and the ADT transmits data if the cart or vehicle is moving. The addition of a rechargeable battery charged only by the ADT's activatable power generating component would let the ADT transmit data intermittently when the wheel is not generating power. The data may be any sensed information including the location, based on a sensing receiver part of the ADT. This sensor may be a global positioning system (GPS) or other location sensing receiver based on signal strength, direction, triangulation and/or other method. The transmitted data would be received by the Data Receiver and may be displayed, overlaid on a plan or map to show the location of the ADT equipped vehicle or used in some other way depending upon the data transmitted. There would be no other source of power other than the self contained ADT.

For the ADT, any wireless transmitter technology can be used. Examples of wireless technologies that can be used in the practice of the invention are well know in the art and may include those used in short and medium range WLAN, WPAN, Bluetooth, WUSB, UWB, Near Field Communication, EnOcean, ZigBee or even longer range technologies such as: WiFi, HiperLAN, WMAN, HiperMAN, WiMax, cellular technologies including GSM or any other available or suitable wireless technology. The ADT may also use other short range transmitter technologies used in cordless telephony, remote controls, wireless security systems and the like. The Data Repeater and the Data Receiver may use wireless or non wireless communication or networking technologies.

The sensors may be any known or to be developed in the art. Examples may include sensors that detect heat/cold (or changes in temperature), light/dark (or changes in levels, types or wavelengths of light), proximity, infrared, radiation, presence/absences of gases (for example, carbon dioxide, carbon monoxide), volatilized hydrocarbons, motion or changes in pattern or speed of motion, UV radiation, biological hazards (such as spores, proteins, nucleic acids and other cellular or viral components), pH, presence of particles and their attributes, moisture/humidity levels, mechanical including vibrations, sounds, air or atmospheric and other pressures, flow velocity, material density, the presence/absence of any other detectable chemical electromagnetic that detect electrical, magnetic or radar levels, motion, distance or any other phenomena or materials that can be sensed now or in the future.

Examples of sensors include detectors for natural gas presence warning in the home; smoke in building spaces indicating fire or danger; motion and glass break for security intrusion situations; biological sensors that sense light, motion, temperature, magnetic fields, gravity, humidity, and other physical aspects of the external environment; tire pressure sensors, radiation, engine combustion to warn of possible problems, fire and heat in any environment, thermostat to measure temperatures, sensors that detect chemical or biological element presence and the like.

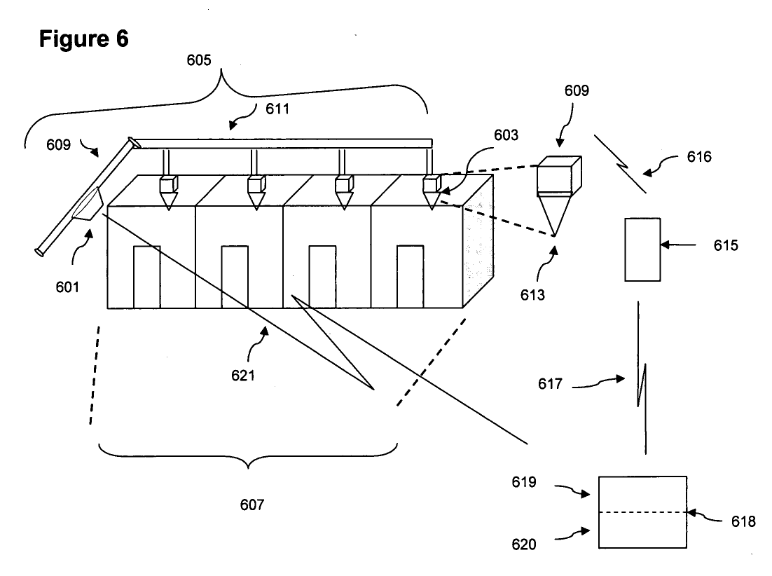

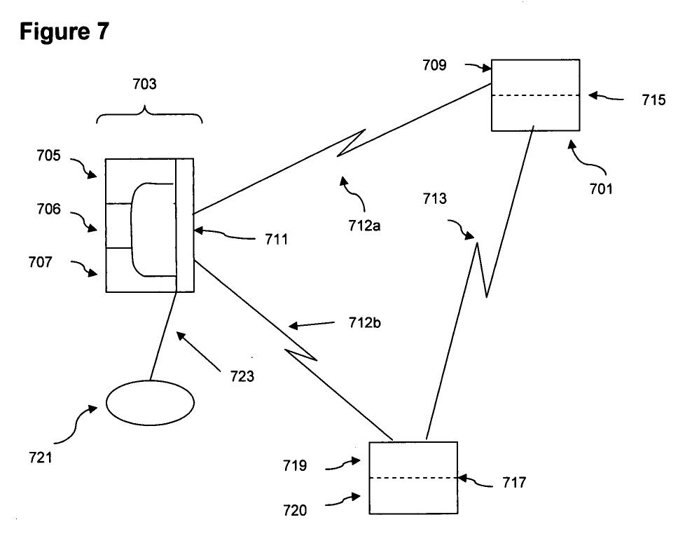

In general when the power activation occurs the sensor data is transmitted. After such activation occurs, sensor data transmission begins on a initially stimulated basis and continues, once started continues with a set time frequency thereafter, on a as stimulated basis only, on a continuing basis when once started (stops are treated as data events) or some combination thereof depending upon the application, the type of activatable power generating component selected and/or the intended purpose or use. For instance in FIG. 6 we know that when fire opens the sprinkler head 613 in a building fire suppression system 605 and water begins to flow from the sprinkler head 613. In an embodiment of this invention the water flow activates a turbine power component of the ADT 609 which is integrated 603 with the sprinkler head(s) 613 or included as part of the piping system 611 feeding the sprinkler head(s) 613 and provides a wireless transmission 616 of data which may include flow activation indication, flow speed, temperature of proximal space, presence of smoke and/or other sensed elements as determined at the installation of the ADT 609 to the Data Repeater 615. One or more Data Repeaters will retransmit 617 the data to the Receiver System 618. Additionally, a separate ADT 601 would provide data 621 from the piping system 611 feeding the sprinkler heads 613 in the building zone 607.

The activatable power generating component of an ADT is defined as any source of power that is proximal, connected or linked to or integrated with the ADT; is present for the purpose of powering ADTs and is the sole source of power for ADTs. The activatable power generating component may be any that is known or to be developed in the art, as long as it not at all reliant on a conventional replaceable battery or the wired power grid. Examples include power generating sources that include an a turbine (water, wind, air, gas, steam, etc,), a solar cell, light cell, a photovoltaic array, a solid state generator, a thermoionic converter, a fuel cell, a electro-bio cell, solar or other steam generator, an electrochemical cell, a thermoelectric module, a nuclear generator, a fuel/gas powered generator, a vibration generator, a motion generator, a kinetic generator, a thermo-photovoltaic converter, a wet cell, any combustion driven generator, any other form of device or set of components that can become a activatable power generating component of the ADT now or in the future or any combination thereof.

There may, depending upon the particular embodiment of an ADT, be some additional circuitry, wiring, programming or related technology required to link, connect or integrate the components of the ADT into an operating entity. Also depending on its use or environment their may be some different types of packaging required to house the ADT device and/or its components or adapt them to the intended purpose and environment.

The Receiver System in addition to a receiver that can receive data from the ADT wirelessly or from a Data Repeater wirelessly or non wirelessly may include a software application running on a computer, digital or other device that uses the data from the ADT and processes it according to the instructions programmed, built, hard wired or otherwise coded into the Receiver System application or device. In the simplest case the Receiver System may receive the data transmission inputs that are displayed as received or inputs that are “at”, “in” or “out of” a defined boundary or value previously specified and display it to the user as a light indicator or alarm. In a more grand embodiment it may log or record all data received, by the Receiver System, process it with other data that may be provided from other sources and provide a customized or specialized display to a display attendant or formulate and send automated instructions to another device.

In the first simplest case above using the swimming pool example FIG. 3 the transmitted data of the pool water, temperature or chemical content might be displayed on a cell phone device Receiver System 307. In the example of the door closer embodiment the data transmission from the ADT may be received by the security system; other “notify” or “alarm” display device or a building management system Receiver System. In the embodiment using the greenhouse example FIG. 5 the Receiver System 507 is connected to motors in a greenhouse that operate the fans and control the window based upon light, moisture, temperature and/or other attribute/event. In the example of the waste dump example FIG. 4 the data collected from multiple ADT's 413 is transmitted through a Data Repeater 415 and overlaid on a map of the waste dump then displayed 417 as part of waste dump management system which includes the availability of historical information that could be used to forecast changes to the dump or identify problem areas. Further, in the example of the water flow activation in the fire suppression system mentioned earlier FIG. 6 the ADT 609 transmitted data 616 is received by the Receiver System 618 via the Data Repeater 615 and is displayed to show building managers or first responders the data available from the space or zone 607 where each ADT 609 is located.

The Data Repeater receives data from one or more ADTs and transmits it to the Receiver System. It is an optional device of the invention that is used in circumstances where the data from individual ADTs would be received using a technology compatible to the ADT transmitter; may be enhanced, changed, manipulated, consolidated and/or processed then transmitted to the Receiver System. The Data Repeater transmitter may boost the signal strength, may transmit the data with a technology compatible to the Data Repeater receiver, may use a different technology including both wireless and/or wired communication technologies available and/or may transmit the data using a longer range technology. In any case the technologies employed as part of the Data Receiver would allow receipt of data from the Data Repeater when employed.

It will be appreciated by those skilled in the art that changes could be made to the embodiments described above without departing from the broad inventive concept thereof. It is understood, therefore, that this invention is not limited to the particular embodiments disclosed, but it is intended to cover modifications or additions based upon a particular use within the spirit and scope of the present invention as defined by the appended claims.

I claim:

1. An activatable data transmitter device comprising:
a. a wireless transmitter;
b. an activatable power generating component;
c. a data collecting sensor or detector and
d. additional circuitry, components, wiring, programming and/or packaging necessary to operationally interconnect a, b and c above
wherein the activatable power generating component upon activation by a stimuli generates power for the wireless transmitter

1.5. The transmitter of claim 1, wherein activatable power generating component generates power for the data collecting sensor.

2. The transmitter of claim 1 wherein the activatable power generating component comprises a liquid, wind, air, steam or gas powered turbine.

3. The transmitter of claim 1 wherein the activatable power generating component comprises a solar cell, light cell, motion generator, a kinetic generator, a photovoltaic array, a solid state generator, a nuclear generator, a thermoionic converter, and a thermo-photovoltaic converter, a fuel cell, a electro-bio cell, solar or other steam generator, a thermoelectric module, a electrochemical cell, a fuel/gas powered generator, a vibration generator, any combustion driven generator, a wet cell and the like or any combination thereof.

4. The transmitter of claim 1 wherein the device includes a battery chargeable by the activatable power generating component of claim 1.

5. The transmitter of claim 1, wherein the device includes a memory or data storage device.

6. The transmitter of claim 1, wherein the device includes a RFID device.

7. The transmitter of claim 1, wherein a sensor measures the electrical current and operating status of the activatable power generating component in claim 1.

8. The transmitter of claim 1, wherein the sensor is chosen from types of heat sensors, radiation sensors, gas sensors, chemical sensors, biological sensors, hazard sensors, motion sensors, particulate sensors, particle sensors, flow sensors, viscosity sensors, signal strength sensors, proximity sensors, temperature sensors, pressure sensors, environmental sensors, smell sensors, smoke sensors, heat sensors, fire sensors, noise sensors. electrical sensors, density sensors, mechanical sensors, moisture and humidity sensors, pH sensors, infrared sensors, light sensors, speed sensors, position sensors and the like including combinations thereof.

9. The transmitter of claim 1, wherein the sensor includes connections for a chosen input device for photos, video, audio, GPS or other data input.

10. The transmitter of claim 1, wherein the device has the ability to use any available wireless networking or communication technologies to transmit data.

11. The transmitter of claim 1, wherein the device includes a computer in addition to any included in the any the components (a, b or c) of claim 1.

12. The transmitter of claim 1 wherein the activatable power generating component may directly provide the data to be transmitted.

13. The transmitter of claim wherein device's data collecting sensor may directly provide the power acting as the activatable power generating component.

14. The transmitter of claim 1 wherein the device includes an extended range antenna.

15. The transmitter of claim 1 wherein an input device is substituted as a sensor or detector.

16. The transmitter of claim 1 wherein their may be more than one data collecting sensors, detectors or input devices.

17. The transmitter of claim 1 wherein the device contains a storage container that can hold a liquid, gas or other material.

18. A data repeater composed of a receiver and transmitter that receives the data from the transmitter(s) of claim 1 and transmits it to the receiver system of claim 20 further including the ability to transmit that data using any available wired or wireless networking and communications technologies.

19. The data repeater of claim 18 wherein a computer with control program, data storage device and software is included which is capable of storing, processing, and manipulating received data until it can be transmitted to the receiver system of claim 20.

20. A receiver system comprising the components necessary to receive data from the transmitter of claim 1 and/or claim 18.

21. The receiver system of claim 20 wherein the data received can be displayed.

22. The receiver system of claim 20 wherein the device includes the ability to “alarm”, “notify” or display indicators based on data received.

23. The receiver system of claim 20 wherein the device includes a computer, a control program and network interfaces to receive data from the transmitter of claim 1 and/or claim 18 further comprising:
a. an executable software application program that collects, manipulates, processes calculates, interprets, monitors and/or displays data provided by the transmitter(s) of claim 1 according to a specific set of specifications.
b. a database to store data.

24. The receiver system of claim 20 wherein the functionality of claim 21, 22 and/or 23 is embedded as part of another device, system or software application.

25. The receiver system if claim 20 wherein the processed, manipulated or interpreted data may create actionable data that can be forwarded electronically to another device.

26. The receiver system of claim 20 further including a data transmitter.

27. The receiver system of claim 20 and claim 23 wherein the application is capable of collecting data from other sources to be used with the data collected by the transmitter of claim 1.
